(19) United States
(12) Patent Application Publication
(10) Pub. No.: US 2025/0252441 A1
(43) Pub. Date: Aug. 7, 2025

(54) SYSTEM OF AUTHORIZING FINANCIAL TRANSACTIONS FOR CONSUMERS WITH DISABILITIES

(71) Applicant: MASTERCARD INTERNATIONAL INCORPORATED, Purchase, NY (US)

(72) Inventors: Kumar Abhinav, Pune (IN); Naveen Kumar Singh, Pune (IN); Selwyn Santan Fernandes, Pune (IN); Vinay Kumar, Pune (IN)

(21) Appl. No.: 18/435,388

(22) Filed: Feb. 7, 2024

(51) Int. Cl. G06Q 20/40; G06Q 20/38; G06T 3/40

(52) U.S. Cl. CPC G06Q 20/4014; G06Q 20/382; G06Q 20/386; G06T 3/40

(57) ABSTRACT

An authentication system for financial transactions is disclosed. For non-disabled consumers, the authentication system sends authentication messages that have been formatted using a standard format that is easy for non-disabled consumers to interpret but which is more difficult for disabled consumers to accurately interpret. The authentication system assists disabled consumers by sending authentication messages to disabled consumers in a non-standard format that is easier to interpret than standard authentication messages.

### BACKGROUND

The present inventions relate generally to financial transaction processing, and more particularly, to authorization systems adapted for consumers with disabilities.

Modern consumer payment systems usually involve one or more banks as well as various support services. In such systems, the consumer will typically have an account with a bank that offers cash account or credit account services. When making a purchase from a merchant, the consumer provides the merchant with information about the consumer's account with the bank, such as a credit or debit card number. The merchant then submits the purchase amount and account information to the consumer's bank and receives payment from the bank if the bank approves the transaction.

Because modern consumer payment systems are designed to process thousands of payment requests in short periods of time, such systems tend to attract criminals who seek to deceive the system into paying for purchases from a consumer's bank account that have not been authorized by the consumer. This can be a particular concern with online purchases and other such purchases where the purchaser does not physically present an account card (like a credit card or debit card) to the merchant. In such cases, the purchaser (consumer or criminal) enters account information into an electronic form (like a website) which the merchant then uses to request payment from the consumer's bank. In order to avoid fraud in these types of purchases, it has become more common to require multi-factor authorization to complete a purchase. For example, it may be required for the consumer to also provide the merchant with a one-time use authentication code that a criminal would be unlikely to be able to acquire. Such authentication codes have the potential to greatly decrease unauthorized purchases by criminals who may have acquired a consumer's account information but are unable to acquire authentication codes for the account.

However, one problem with current payment systems is that some consumers have disabilities that make it difficult for them to interpret authentication codes. With these individuals, they may be able to receive an authentication code (e.g., with their phone), but because of a disability, they may not be able to interpret the code in order to provide it to the merchant. One such disability is dyslexia. Individuals with dyslexia have a difficult time interpreting small text characters that are closely spaced together. Older individuals may also have reduced eyesight and may find it difficult to read text of a normal size that younger people are able to read more easily. Thus, it would be desirable to have a multi-factor authorization system for financial transactions that is more easily used by consumers with disabilities.

### SUMMARY

An improved authentication system for financial transactions is described. In the system, an authentication service accesses a database to determine if a particular consumer has a disability identifier associated with the consumer. The authentication service then formats an authentication message according to a first format or a second format. The first format is used by the authentication service when there is no disability identifier associated with the consumer. When a disability identifier is associated with the consumer, the authentication service formats the authentication message using a second format. While the first format (e.g., standard text) is suitable for non-disabled consumers, the second format is easier for disabled consumers to interpret. The formatted message is then sent to the consumer, and upon receiving the authentication message, the consumer provides information from the message to the merchant to complete a purchase. The invention may also include any other aspect described below in the written description or in the attached drawings and any combinations thereof.

### BRIEF DESCRIPTION OF SEVERAL VIEWS OF THE DRAWINGS

The invention may be more fully understood by reading the following description in conjunction with the drawings, in which:

FIG. 1A illustrates an order form on a first user interface, such as a website;

FIG. 1B illustrates an authentication message formatted with a first format displayed on a second user interface, such as a mobile phone;

FIG. 1C illustrates an authentication message formatted with a second format displayed on a second user interface, such as a mobile phone; and

FIG. 2 illustrates a schematic of an authentication system for financial transactions.

### DETAILED DESCRIPTION

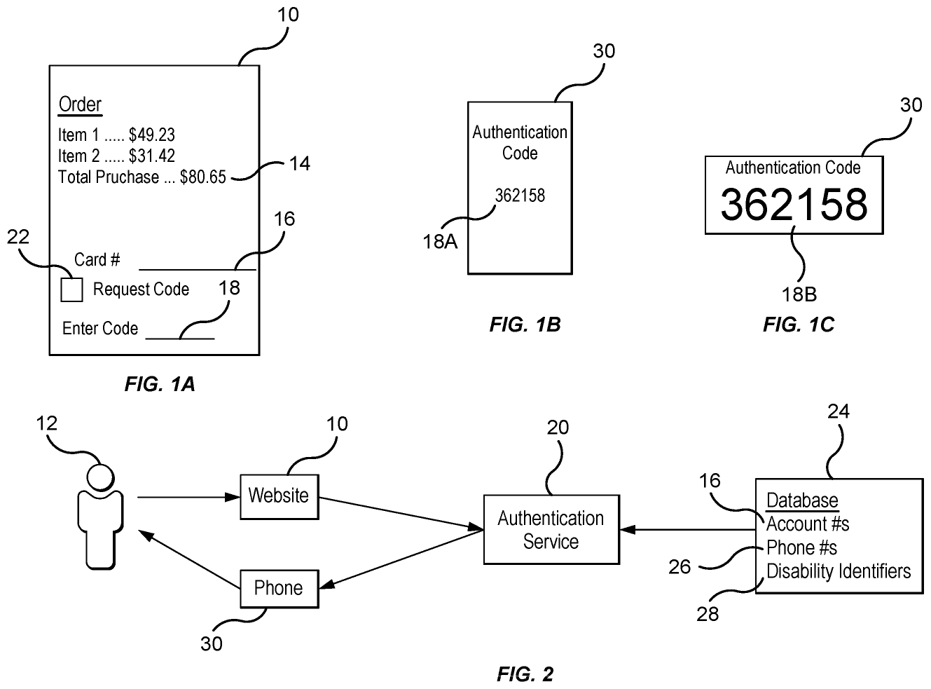

Referring now to the figures, and particularly FIG. 1A, an order screen 10 is shown. As shown, a consumer 12 may wish to place an order for a purchase 14 at a remote location like a website 10 (or first user interface 10). In such situations, the consumer 12 is unable to physically present a credit or debit card to an agent of the merchant to authorize the purchase 14. Instead, the consumer 12 enters a card number 16 (or account information 16) associated with a payment source into a field on the website 10.

In order to ensure increased security, the website 10 may also require the consumer 12 to enter an authentication code 18 before the purchase 14 can be completed. The authentication code may be various types of information provided by an authentication service 20 that is sent in a message to the consumer 12. In order to initiate the authentication code process, a button 22 may be provided on the website 10 to request an authentication code 18. In this particular embodiment, when the consumer 12 pushes the button 22 to request an authentication code 18, the website 10 (or merchant or other service provider) sends a request to an authentication service 20 to provide an authentication code 18 to the consumer 12 as shown in FIG. 2. The authentication service 20 will typically have access to a database 24 with basic information about numerous consumers 12. For example, it is preferable for the database 24 to have information about each consumer including account numbers 16, phone numbers 26 and disability identifiers 28. This information may be collected and entered into the database 24 when consumers 12 apply for a new account, such as a credit or cash account, or may be updated by consumers 12 when any of the consumer's information changes. In most cases, it will be desirable for the disability identifiers 18 to be based on consumers 12 self-identifying themselves as having a disability that makes reading standard characters difficult, which the authentication service 20 may use to update the database 24. In some embodiments, it may be preferred for the card issuer (e.g., the merchant bank) to maintain the database 24 which may be accessed by the authentication service 20 over a secure communication network.

The disability identifier 28 in the database 24 identifies particular individuals as having a disability that makes it difficult for the consumer 12 to see or understand conventional authentication codes 18. Examples of those who may have a disability include consumers 12 with dyslexia and older consumers 12 with poor eyesight. It is expected that most consumers 12 in the database 24 will not have a disability, and thus, most consumers 12 in the database 24 will not have a disability identifier 28 associated with them. Instead, only a subset of the consumers 12 (e.g., less than 10%) are expected to have a disability identifier 28 associated with them. Once the authentication service 20 determines whether the consumer 12 has a disability by checking for the disability identifier 28 in the database 24, the authentication service 20 formats a message to be sent to the consumer 12. That is, the message is formatted according to two different formats 18A, 18B depending on whether the consumer 12 has a disability. For example, if the consumer 12 does not have a disability, the message may be formatted as standard text 18A as shown in FIG. 1B. By contrast, if the consumer 12 has a disability, the message may be formatted as enlarged text 18B that is easier to see as shown in FIG. 1C. For example, it may be desirable for the enlarged text format 18B to have characters that are at least three times larger than standard text 18A.

The authentication service 20 then sends the message to a second user interface 30 which the consumer 12 has access to. Once the consumer 12 receives the authentication message, the consumer enters information 18 from the message into the website 10 to complete the order 14. It is understood that the merchant, authentication service 20 or some other service provider then confirms that the consumer 12 has entered an authentication code 18 that matches the code 18 (i.e., information 18) that was sent to the consumer 12. Like some conventional authentication systems, it may be preferred for the authentication service 20 to send a message to a mobile phone 30 owned by the consumer 12. Thus, the system provides added security since it is unlikely that a criminal will have both a consumer's account information 16 and mobile phone 30 for receiving the authentication message 18.

The authentication message 18 and the formatting thereof may take various forms. For instance, where the second format 18B for disabled consumers 12 is enlarged relative to the first format 18A for standard consumers 12, it may be desirable for the enlarged characters of the second format 18B to utilize at least 25% of the width or length of the total screen size of the user interface 30 (e.g., a mobile phone 30) that the message information 18 will be displayed on. Preferably, the authentication message includes a code 18 made up of multiple random characters that the consumer 12 inputs into the first user interface 10 (e.g., the website 10). More preferably, the message includes a one-time password 18 that is only enabled for a short period of time before it expires and is unusable after it has been entered into the first user interface 10 or after it has expired. In some embodiments, the message may include a numerical code 18 that the consumer 12 enters into the first user interface 10. However, it is also possible for the message to include an image 18 of a non-textual object like a bridge, bicycle or traffic light that the consumer obtains information from to enter into the first user interface 10 (e.g., like a CAPTCHA). In this case, the second format 18B for disabled consumers 12 may enlarge the image 18 so that it is easier to see. In another embodiment, the second format 18B for disabled consumers 12 may be specifically designed for dyslexic consumers 12. For example, where the first format 18A for standard consumers 12 includes a plurality of characters that are displayed together in the second user interface 30, the second format 18B for disabled consumers 12 may instead display each of the characters one at a time in sequential order on the second user interface 30. That is, the first character of the message code 18B may be displayed on the screen 30 by itself momentarily (and preferably enlarged), and then the first character is erased from the user interface 30 and the second character is momentarily displayed and so on until all of the characters have been displayed. This format 18B may be easier for dyslexic consumers 12 to interpret because the characters of the message are not displayed next to each other which can be confusing for dyslexic consumers 12. In this embodiment, after all of the characters have been displayed individually, it may also be desirable to display the entire message code 18B together (and preferably enlarged). In particular embodiments, the second format 18B may be incorporated into a video file or graphic image (e.g., AVI or GIF file).

Although the second user interface 30 may be various types of screens on different kinds of electronic devices, it is generally preferred for the second user interface 30 to be the screen of the consumer's mobile phone 30 since a mobile phone number 26 can be easily linked to a consumer 12 in the database 24 used by the authentication service 20 and consumers 12 usually keep their mobile phones 30 close to themselves and notice fairly quickly if their phone 30 has been lost or stolen. Where a mobile phone 30 is used as the second user interface 30, it may be desirable for the authentication message 18 to be received by a special authentication app loaded on the phone 30. This may be desirable so that the authentication app can be equipped with format reading algorithms that can read the first and/or second format 18A, 18B and display the formats as intended. For example, in one embodiment, it may be desirable for the authentication service 20 to send all authentication messages 18 for both standard consumers 12 and disabled consumers 12 to a special authentication app, and the authentication app will distinguish between the two formats 18A, 18B and display the message information 18 according to whichever format has been assigned to the message 18 by the authentication service 20. Alternatively, because standard consumers 12 do not require special formatting of authentication messages 18, the authentication service 20 could direct authentication messages 18 with the first standard format 18A to a standard texting app (e.g., SMS) on the consumer's mobile phone 30. A standard texting app may be preferred for non-disabled consumers 12 because consumers 12 are already familiar with using texting apps to exchange information. However, most standard texting apps do not allow information to be formatted as is desired for disabled consumers 12. Thus, while non-disabled consumers 12 may prefer to use a standard texting app, such standard texting apps are generally less suitable for disabled consumers 12. Thus, in this case, only specially formatted authentication messages 18B may be sent to a non-standard authentication app on the consumer's mobile phone 30 associated with authentication service 20 that is capable of reading and displaying the special format 18B assigned to disabled consumers 12.

In other embodiments, it may be desirable for consumers 12 to use an email system to receive authentication messages 18. Although authentication email messages 18 may be sent for both standard and disabled consumers 12, it may be more preferable to only send authentication email messages 18B for disabled consumers 12 and to send non-email authentication messages 18A (e.g., standard text messages) for standard consumers 12. It may also be desirable for the second format 18B for disabled consumers 12 to be an audio clip message that disabled consumers 12 can listen to (e.g., on a mobile phone 30). By contrast, standard consumers 12 may receive a standard text message 18A that the consumer 12 must read in order to acquire the necessary information 18A to input into the website 10 to complete the order 14.

It is understood that the described improved authentication system is intended to operate autonomously on programmed computer systems utilizing computer algorithms such that the system may be implemented by one or more computer processors (e.g., in a server system) executing computer-executable instructions stored on a non-transitory computer-readable storage medium. Thus, for example, in the case of the authentication service 20 it is unnecessary for human beings to make the required determinations or receive or send messages, etc. This autonomous design makes the improved system scalable to a level that would be impractical if human beings were to attempt to perform the steps required by the system. While it is understood that various human beings may provide inputs to the system and may adjust parameters that control how the system operates, the improved authentication system is intended to have the capability of processing many thousands of authentications in short periods of time (e.g., seconds or less) that would be impossible to accomplish with human intervention in each authentication.

While preferred embodiments of the inventions have been described, it should be understood that the inventions are not so limited, and modifications may be made without departing from the inventions herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

1. A system of authorizing financial transactions, comprising:
a database storing account information for many consumers comprising a disability identifier associated with a subset of the many consumers;
a first user interface for purchasing a good or service from a merchant, wherein a consumer initiates a purchase by entering account information associated with a payment source into the first user interface;
an authentication service having access to the database, wherein the authentication service receives a request to initiate authentication in response to the account information being entered into the first user interface;
the authentication service determining from the database whether the consumer is within the subset of the many consumers by checking the disability identifier for the consumer;
a second user interface for authenticating the consumer, wherein a message is sent to the second user interface by the authentication service in response to the request to initiate authentication, the authentication service formatting the message according to a first format if the consumer is not within the subset of the many consumers and formatting the message according to a second format if the consumer is within the subset of the many consumers;
the second format being easier for the subset of the many consumers to interpret compared to the first format; and
wherein the consumer inputs information from the message into the first user interface to authenticate the consumer and complete the purchase.

2. The system of authorizing financial transactions according to claim 1, wherein the second format enlarges the size of the information within the message which the consumer inputs into the first user interface relative to the first format.

3. The system of authorizing financial transactions according to claim 1, wherein the message is a numerical code.

4. The system of authorizing financial transactions according to claim 1, wherein the message is a one-time password.

5. The system of authorizing financial transactions according to claim 1, wherein the second format enlarges characters at least three times larger than characters in the first format.

6. The system of authorizing financial transactions according to claim 1, wherein the second format enlarges characters to utilize at least 25% of a width or length of a total screen size of the second user interface.

7. The system of authorizing financial transactions according to claim 1, wherein the message includes a code with a plurality of characters, the plurality of characters of the code being the information input by the consumer into the first user interface.

8. The system of authorizing financial transactions according to claim 7, wherein the first format displays all of the plurality of characters together in the second user interface, and the second format displays each of the plurality of characters separately in the second user interface such that each of the plurality of characters is displayed sequentially one after another with each of the plurality of characters being displayed momentarily by itself.

9. The system of authorizing financial transactions according to claim 1, wherein the message includes an image of a non-textual object, the image being enlarged in the second format compared to the first format.

10. The system of authorizing financial transactions according to claim 1, wherein the second user interface comprises an authentication app loaded onto a mobile phone of the consumer, the message being sent by the authentication service to a phone number for the mobile phone of the consumer.

11. The system of authorizing financial transactions according to claim 10, wherein the authentication app displays the message according to the first or second format as assigned to the message by the authentication service.

12. The system of authorizing financial transactions according to claim 1, wherein the second user interface comprises an email system when the consumer is within the subset of the many consumers with the disability identifier, the message being an email sent by the authentication service to an email address of the consumer.

13. The system of authorizing financial transactions according to claim 1, wherein the first format comprises sending the message as a text message without special formatting to a standard texting app on a mobile phone of the consumer, and the second format comprises sending the message to a non-standard authentication app associated with the authentication service loaded onto the mobile phone of the consumer.

14. The system of authorizing financial transactions according to claim 1, wherein the second format comprises sending the message as an audio clip such that the consumer listens to the message to acquire the information to input into the first user interface, and the first format comprises sending a text message such that the consumer reads the message to acquire the information to input into the first user interface.

15. The system of authorizing financial transactions according to claim 1, wherein the consumer self-identifies themselves as having a disability in reading characters, the authentication service updating the database with the disability identifier for the consumer in response to the self-identification.

16. The system of authorizing financial transactions according to claim 1, wherein the second format enlarges the size of the information within the message which the consumer inputs into the first user interface relative to the first format, and the message includes a code with a plurality of characters, the plurality of characters of the code being the information input by the consumer into the first user interface.

17. The system of authorizing financial transactions according to claim 16, wherein the second user interface comprises an authentication app loaded onto a mobile phone of the consumer, the message being sent by the authentication service to a phone number for the mobile phone of the consumer.

18. The system of authorizing financial transactions according to claim 17, wherein the consumer self-identifies themselves as having a disability in reading characters, the authentication service updating the database with the disability identifier for the consumer in response to the self-identification.

19. The system of authorizing financial transactions according to claim 18, wherein the second format enlarges the plurality of characters at least three times larger than the plurality of characters in the first format.

20. The system of authorizing financial transactions according to claim 19, wherein the first format displays all of the plurality of characters together in the second user interface, and the second format displays each of the plurality of characters separately in the second user interface such that each of the plurality of characters is displayed sequentially one after another with each of the plurality of characters being displayed momentarily by itself.
